(19) United States
(12) Patent Application Publication
(10) Pub. No.: US 2011/0276775 A1
(43) Pub. Date: Nov. 10, 2011

(54) METHOD AND APPARATUS FOR CONCURRENTLY READING A PLURALITY OF MEMORY DEVICES USING A SINGLE BUFFER

(75) Inventor: Roland SCHUETZ, Ottawa (CA)

(73) Assignee: MOSAID TECHNOLOGIES INCORPORATED, Ottawa (CA)

(21) Appl. No.: 13/102,310

(22) Filed: May 6, 2011

Related U.S. Application Data
(60) Provisional application No. 61/332,232, filed on May 7, 2010.

(51) Int. Cl. G06F 12/02

(52) U.S. Cl. 711/165; 711/E12.002

(57) ABSTRACT

A composite memory device including discrete memory devices and a bridge device for controlling the discrete memory devices in response to global memory control signals having a format or protocol that is incompatible with the memory devices. The discrete memory devices can be commercial off-the-shelf memory devices or custom memory devices which respond to native, or local memory control signals. The global and local memory control signals include commands and command signals each having different formats. The composite memory device includes a system in package including the semiconductor dies of the discrete memory devices and the bridge device, or can include a printed circuit board having packaged discrete memory devices and a packaged bridge device mounted thereto.

### CROSS REFERENCE TO RELATED APPLICATIONS

This application claims the benefit of priority from U.S. Provisional Patent Application No. 61/332,232 filed May 7, 2010, the disclosure of which is expressly incorporated herein by reference in its entirety.

### FIELD OF INVENTION

The present invention relates to generally a semiconductor device, and in particular to reading data from a plurality of sources using a single buffer of the semiconductor device.

### BACKGROUND

Semiconductor memory devices are important components in presently available industrial and consumer electronics products. For example, computers, mobile phones, and other portable electronics all rely on some form of memory for storing data. While many memory devices are typically available as commodity, or discrete memory devices, the need for higher levels of integration and higher input/output (I/O) bandwidth has led to the development of embedded memory, which can be integrated with systems, such as microcontrollers and other processing circuits.

Most consumer electronics employ, non-volatile devices, such as flash memory devices, for storage of data. Demand for flash memory devices has continued to grow significantly because these devices are well suited in various applications that require large amounts of non-volatile storage, while occupying a small physical area. For example, flash is widely found in various consumer devices, such as digital cameras, cell phones, universal serial bus (USB) flash drives and portable music players, to store data used by these devices. Also, flash devices are used as solid state drives (SSDs) for hard disk drive (HDD) replacement. Such portable devices are preferably minimized in form factor size and weight. Unfortunately, multimedia and SSD applications require large amounts of memory which can increase the form factor size and weight of their products. Therefore, consumer product manufacturers compromise by limiting the amount of physical memory included in the product to keep its size and weight acceptable to consumers. Furthermore, while flash memory has a higher density per unit area than DRAM or SRAM, its performance is limited due to its relatively low I/O bandwidth that negatively impacts its read and write throughput.

FIG. 1A illustrates a flash memory system known in the art, which has multiple discrete flash memory devices and a memory controller connected in parallel to a channel. This is known as a multi-drop memory configuration. FIG. 1B is a diagram of one of the discrete flash memory devices which can be used in the memory system of FIG. 1A, showing in particular the memory device interface. FIGS. 1A and 1B are described in detail later. This discrete flash memory device can be well known NAND flash memory device, which is widely available and therefore inexpensive to purchase. Those skilled in the art should understand that NAND flash memory devices typically output at least one unit of data, referred to as a page of data, which is read from the memory array in a read operation. The memory system of FIG. 1A using the discrete memory devices of FIG. 1B suffers from speed and capacity limitations.

FIG. 2A is a block diagram illustrating the conceptual nature of a serial memory system, where discrete serial interface memory devices are connected serially with each other and a memory controller. FIG. 2B is a diagram of the serial interface flash memory device which can be used in the memory system of FIG. 2A, showing in particular its memory device interface. FIGS. 2A and 2B are described in detail later. The serial memory system of FIG. 2A using the discrete serial interface memory devices of FIG. 2B can achieve greater memory capacity and speed than the multi-drop memory system of FIG. 1A. The memory device of FIG. 2A can output at least one page of data read from the memory array in a read operation. Unfortunately, the discrete serial interface memory devices of FIG. 2B have a different memory interface than the NAND flash memory device of FIG. 1B, and therefore cannot be interchangeably used with each other.

In order to take advantage of the improved speed of the memory device interface of FIG. 2B and of the widely available and inexpensive NAND flash memory devices, a bridge device has been developed which functions as an interface adaptor between multiple NAND flash memory devices connected to it and a memory controller which operates with the discrete serial interface shown in FIG. 2B. As shown in FIG. 3B by example, the bridge device and multiple discrete NAND flash memory devices can be packaged together into a packaged memory device.

The bridge device includes a buffer, such as SRAM memory for example, for receiving and buffering the pages of read data from the memory devices and outputting the read data to the memory controller. The cost of the bridge device is driven mainly by its area, and the area of the bridge device is dominated by the size of the SRAM memory. Therefore, to minimize the cost of the bridge device, the SRAM memory should be minimized. This could mean that multiple discrete NAND flash memory devices share one data buffer of the bridge device that is sized for storing only one page of data. Therefore contention for the limited data buffer space between the discrete memory devices will arise, and data could be lost if a second memory device is outputting data to the bridge device, while a first memory device has access to the data buffer of the bridge device. Alternately, the discrete memory devices can have the capability to output multiple pages of data, which further compounds the problem of access to the data buffer.

Therefore, an improved bridge device having a minimally sized data buffer which can control access by the discrete memory devices, is needed.

### SUMMARY

In a first aspect, there is provided a method for controlling data transfer from two page buffer sources to a data buffer. The method includes initiating read operations in the two page buffer sources; automatically transferring data from a first page buffer source of the two page buffer sources that completes a read operation, to the data buffer; inhibiting transfer of data from a second page buffer source of the two page buffer sources when the second page buffer source completes a read operation and the data buffer is busy; waiting for the data buffer to become available; and, transferring data from the second page buffer source when the data buffer is available. According to embodiments of the first aspect, each of the two page buffer sources and the data buffer are sized to store one page of data, the first page buffer source is a first memory device and the second page buffer source is a second memory device, or the first page buffer source is a first page buffer of a memory device and the second page buffer source is a second page buffer of the memory device.

In another embodiment of the present aspect, automatically transferring data includes receiving a ready signal from the first page buffer source, and further includes issuing a data transfer command to the first page buffer source after the read signal is received from the first page buffer source. In yet another embodiment, inhibiting transfer of data includes setting a deferred status of the second page buffer source if the read operation for the second page buffer source is in progress, and setting a deferred status includes setting a deferred status register corresponding to the second page buffer source to a deferred state. In this embodiment, transferring data includes setting the deferred status register to a non-deferred state. In the present embodiment, inhibiting transfer of data includes receiving a ready signal from the second page buffer source and inhibiting issuance of a data transfer command to the second page buffer source after the read signal from the second page buffer source is received and the second page buffer source is set to the deferred status.

In an embodiment of the first aspect, waiting includes outputting the data of the first page buffer source stored in the data buffer, and transferring data includes issuing a data transfer command to the second page buffer source after the data buffer has finished outputting the data of the first page buffer source. In an alternate embodiment of the 1st aspect, inhibiting transfer of data includes setting a deferred status for the second page buffer source when the ready signal is received, where setting a deferred status includes setting a deferred status register corresponding to the second page buffer source to a deferred state.

In a second aspect, there is provided a method for reading data from a bridge device having two page buffer sources connected to a channel of the bridge device. The method includes issuing page read commands for reading data from the two page buffer sources to the bridge device; determining a first page buffer source of the two page buffer sources is in a ready state and is in a non-deferred state for indicating that data of the first page buffer source is stored in a data buffer of the bridge device; burst reading data from the data buffer of the bridge device; re-issuing a page read command to a second page buffer source of the two page buffer sources if the second page buffer source is in a ready state and is in a deferred state for transferring data of the second page buffer source to the data buffer of the bridge device; and, burst reading data from the data buffer of the bridge device.

In an embodiment of the second aspect, issuing page read commands includes issuing a first page read command to the first page buffer source, followed by issuing a second page read command to the second page buffer source after a predetermined latency period, such that the first page buffer source reads a page of data from a memory array and transfers the page of data to the data buffer of the bridge device in response to the first page read command. The bridge device sets a deferred status for the second page buffer source when the transfer of the page of data to the data buffer is initiated. In another embodiment of the second aspect, determining includes reading status registers of the bridge device indicating the ready state and the non-deferred state corresponding to each of the first page buffer source and the second page buffer source. In yet another embodiment, re-issuing includes reading the status registers of the bridge device to determine if the second page buffer source is in the ready state and in the deferred state where the second page buffer source reads a page of data from a memory array and transfers the page of data to the data buffer of the bridge device in response to the page read command. In this embodiment, the status registers of the bridge device are read to determine if the second page buffer source is in a ready state for indicating that data of the second page buffer source is stored in a data buffer of the bridge device.

In a third aspect, there is provided a bridge device for receiving read data from a first page buffer source and a second page buffer source. The bridge device includes a data buffer, and arbitrator circuit and a controller. The data buffer has a predetermined size for receiving first read data from the first page buffer source and the second read data from the second page buffer source, where the first read data and the second read data have the predetermined size. The arbitrator circuit generates a first read transfer signal in response to detecting a first page buffer source being ready to provide the first read data, and for inhibiting generation of a second read transfer signal when the second page buffer source becomes ready to provide the second read data at least when the first page buffer is ready to provide the first read data. The controller issues a data transfer command to the first page buffer source in response to the first read transfer signal for transferring the first read data from the first page buffer source to the data buffer from the first page buffer source to the data buffer.

According to an embodiment of the third aspect, the first page buffer source is a first memory device and the second page buffer source is a second memory device, and the arbitrator circuit receives a first ready/busy signal transition from the first memory device indicating that the first memory device you is ready to provide the first read data, and receives a second ready/busy signal transition from the second page buffer source after the first ready/busy signal transition. According to an alternate embodiment of the third aspect, the first page buffer is a first plane of a memory device and the second page buffer source is a second plane of the memory device, and the arbitrator circuit receives a ready/busy signal transition from the memory device indicating that the first plane and the second plane are ready to provide the first read data and the second read data.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A is a block diagram of an example non-volatile memory system;

FIG. 1B is a diagram of a discrete flash memory device used in the example memory system of FIG. 1A;

FIG. 2A is a block diagram of an example serial memory system;

FIG. 2B is a diagram of a discrete serial interface flash memory device used in the example memory system of FIG. 2A;

FIG. 3A is a block diagram of a composite memory device having four discrete memory devices and a bridge device, in accordance with a present embodiment;

FIG. 3B is an illustration of a global command, according to a present embodiment;

FIG. 4 is a block diagram of a composite memory device having four discrete memory devices and a bridge device, in accordance with another embodiment;

FIG. 5 is a block diagram of a single plane flash memory device;

FIG. 6 is a block diagram of a multiplane flash memory device;

FIG. 7 is a flow chart of a method for transferring data from multiple sources to a limited memory space, according to a present embodiment;

FIG. 8 is a flow chart of a method for transferring a page of data from multiple flash devices to a limited memory space, according to a present embodiment;

FIG. 9 is a status register definition table for a bridge device, according to a present embodiment;

FIG. 10 is a sequence diagram illustrating an example transfer operation from two flash devices to a limited memory space, according to a present embodiment;

FIG. 11 is a flowchart of a method for controlling a bridge device, according to a present embodiment;

FIG. 12 is a flow chart of a method for transferring multiple pages of data from a single flash device to a limited memory space, according to a present embodiment;

FIG. 13 is a status register definition table for a bridge device, according to an alternate embodiment;

FIG. 14 is a sequence diagram illustrating an example 2 page transfer operation from a single flash device, according to a present embodiment;

FIG. 15 is a simplified block diagram of a bridge device having a data transfer arbitrator, according to a present embodiment; and

FIG. 16 is a schematic of a transfer arbitrator circuit, according to a present embodiment.

### DETAILED DESCRIPTION

Generally, the embodiments of the present invention are directed to a composite memory device including discrete memory devices and a bridge device for controlling the discrete memory devices in response to global memory control signals having a format or protocol that is incompatible with the memory devices. The discrete memory devices can be commercial off-the-shelf memory devices or custom memory devices, which respond to native, or local memory control signals. The bridge device functions as an interface between the discrete memory devices and the system by converting the global memory control signals into the native format compatible with the discrete memory devices. Write data is received by the bridge device and transferred to the addressed discrete memory device, and the bridge device receives read data from the discrete memory devices for transfer to the host.

It should be noted that the following description interchangeably uses the expressions “high logic state” and “logic 1 state”, which are intended to be the same. Similarly, the expressions “low logic state” and “logic 0 state” are intended to be the same.

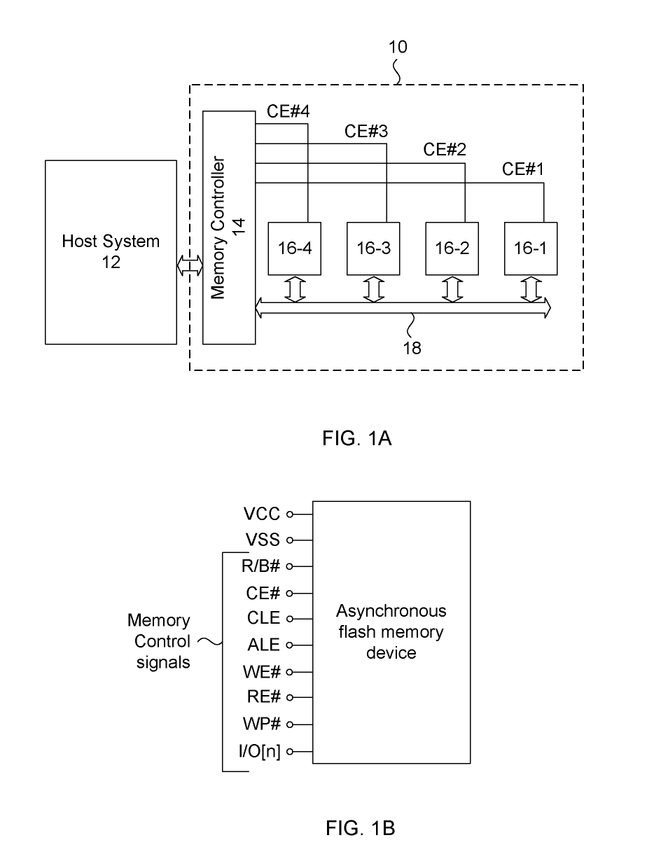

FIG. 1A illustrates a flash memory system known in the art. FIG. 1A is a block diagram of a non-volatile memory system 10 integrated with a host system 12. The system 10 includes a memory controller 14 in communication with host system 12, and a plurality of non-volatile memory devices 16-1, 16-2, 16-3 and 16-4. For example the non-volatile memory devices 16-1-16-4 can be discrete asynchronous flash memory devices. The host system 12 includes a processing device such as a microcontroller, microprocessor, or a computer system. The system 10 of FIG. 1A is organized to include one channel 18, with the memory devices 16-1-16-4 being connected in parallel to channel 18. Those skilled in the art should understand that the system 10 can have more or fewer than four memory devices connected to it. In the presently shown example, the memory devices 16-1-16-4 are asynchronous and connected in parallel with each other.

Channel 18 includes a set of common buses, which include data and control lines that are connected to all of its corresponding memory devices. Each memory device is enabled or disabled with respective chip select (enable) signals CE1#, CE2#, CE3# and CE4#, provided by memory controller 14. In this and following examples, the “#” indicates that the signal is an active low logic level signal. In this scheme, one of the chip select signals is typically selected at one time to enable a corresponding one of the non-volatile memory devices 16-1-16-4. The memory controller 14 is responsible for issuing commands and data, via the channel 18, to a selected memory device in response to the operation of the host system 12. Read data output from the memory devices is transferred via the channel 18 back to the memory controller 14 and host system 12. The system 10 is generally said to include a multi-drop bus, in which the memory devices 16-1-16-4 are connected in parallel with respect to channel 18.

FIG. 1B is a diagram of one of the discrete flash memory devices 16-1-16-4 which can be used in the memory system of FIG. 1A. This flash memory device includes several input and output ports, which include for example power supply, control ports and data ports. The term “ports” refers to a generic input or output terminals into the memory device, which includes package pins, package solder bumps, chip bond pads, and wireless transmitters and receivers for example. The power supply ports include VCC and VSS for supplying power to all the circuits of the flash memory device. Additional power supply ports can be provided for supplying only the input and output buffers, as is well known in the art. Table 1 below provides a listing of the control and data ports, their corresponding descriptions, definitions, and example logic states. It is noted that that package pins and ball grid arrays are physical examples of a port, which is used for interconnecting signals or voltages of a packaged device to a board. The ports can include other types of connections, such as for example, terminals and contacts for embedded and system-in-package (SIP) systems.

TABLE 1

| Port | Description |
|---|---|
| R/B# | Ready/Busy: the R/B# is open drain port and the output signal |
| | is used to indicate the operating condition of the device. The |
| | R/B# signal is in Busy state (R/B# = LOW) during the |
| | Program, Erase and Read operations and will return to Ready |
| | state (R/B# = HIGH) after completion of the operation. |
| CE# | Chip Enable: the device goes into a low-power Standby mode |
| | when CE# goes HIGH during the device is in Ready state. The |
| | CE# signal is ignored when device is in Busy state (R/B# = |
| | LOW), such as during a Program or Erase or Read operation, |
| | and will not enter Standby mode even if the CE# input goes |
| | HIGH |
| CLE | Command Latch Enable: the CLE input signal is used to control |
| | loading of the operation mode command into the internal |
| | command register. The command is latched into the command |
| | register from the I/O port on the rising edge of the WE# |
| | signal while CLE is HIGH. |
| ALE | Address Latch Enable (ALE): the ALE signal is used to control |
| | loading address information into the internal address register. |
| | Address information is latched into the address register from |
| | the I/O port on the rising edge of the WE# signal while ALE |
| | is HIGH. |
| WE# | Write Enable: the WE# signal is used to control the acquisition |
| | of data from the I/O port. |
| RE# | Read Enable: the RE signal controls serial data output. Data |
| | is available after the falling edge of RE#. |
| WP# | Write Protect: the WP# signal is used to protect the device |
| | from accidental programming or erasing. The internal |
| | voltage regulator (high voltage generator) is reset when WP# |
| | is LOW. This signal is usually used for protecting the data |
| | during the power-on/off sequence when input signals are invalid. |
| I/O[n] | I/O Port: are used as a port for transferring address, |
| | command and input/output data to and from the device. |
| | Variable n can be any non-zero integer value. |

All the signals noted in Table 1 are generally referred to as the memory control signals for operation of the example flash memory device illustrated in FIG. 1B. It is noted that the last port I/O[n] is considered a memory control signal as it can receive commands which instruct the flash memory device to execute specific operations.

Each of the non-volatile memory devices of FIG. 1A has one specific data interface for receiving and providing data. In the example of FIG. 1A, this is a parallel data interface commonly used in asynchronous flash memory devices. Standard parallel data interfaces providing multiple bits of data in parallel are known to suffer from well known communication degrading effects such as cross-talk, signal skew and signal attenuation, for example, which degrades signal quality, when operated beyond their rated operating frequency.

In order to increase data throughput, a memory device having a serial data interface has been disclosed in commonly owned U.S. Patent Publication No. 20070153576 entitled “Memory with Output Control”, and commonly owned U.S. Patent Publication No. 20070076502 entitled “Daisy Chain Cascading Devices” which receives and provides data serially at a frequency, for example, 200 MHz. This is referred to as a serial data interface format. As shown in these commonly owned patent publications, the described memory device can be used in a system of memory devices that are serially connected to each other.

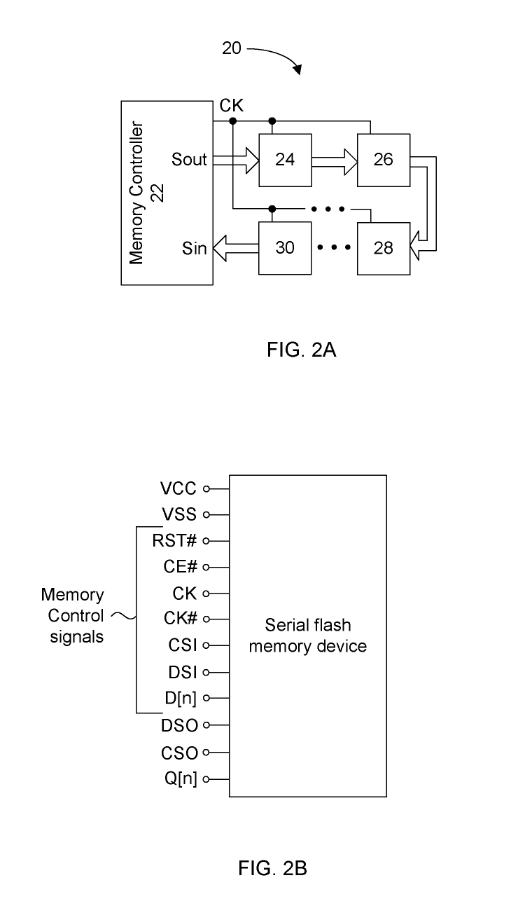

FIG. 2A is a block diagram illustrating the conceptual nature of a serial memory system. In FIG. 2A, the serial ring-topology memory system 20 includes a memory controller 22 having a set of output ports Sout and a set of input ports Sin, and memory devices 24, 26, 28 and 30 that are connected in series. The memory devices can be serial interface flash memory devices for example. While not shown in FIG. 2A, each memory device has a set of input ports Sin and a set of output ports Sout. These sets of input and output ports includes one or more individual input/output ports, such as physical pins or connections, interfacing the memory device to the system it is a part of. In one example, the memory devices can be flash memory devices. Alternately, the memory devices can be DRAM, SRAM, DiNOR Flash EEPROM, Serial Flash EEPROM, Ferro RAM, Magneto RAM, Phase Change RAM, or any other suitable type of memory device that has an input/output interface compatible with a specific command structure, for executing commands or for passing commands and data through to the next memory device. The current example of FIG. 2A includes four memory devices, but alternate configurations can include a single memory device, or any suitable number of memory devices. Accordingly, if memory device 24 is the first device of the system 20 as it is connected to Sout, then memory device 30 is the Nth or last device as it is connected to Sin, where N is an integer number greater than zero. Memory devices 26 to 28 are then intervening serially connected memory devices between the first and last memory devices. In the example of FIG. 2A, the memory devices 24 to 30 are synchronous and connected in series with each other and the memory controller 22.

FIG. 2B is a diagram of the serial interface flash memory device (24 to 30 for example) which can be used in the memory system of FIG. 2A. This example serial interface flash memory device includes power supply ports, control ports and data ports. The power supply ports include VCC and VSS for supplying power to all the circuits of the flash memory device. Additional power supply ports can be provided for supplying only the input and output buffers, as is well known in the art. Table 2 below provides a listing of the control and data ports, their corresponding descriptions, and example logic states.

TABLE 2

| Port | Description |
|---|---|
| CK/ | Clock: CK is the system clock input. CK and CK# are differential |
| CK# | clock inputs. All commands, addresses, input data and output data |
| | are referenced to the crossing edges of CK and CK# in both |
| | directions. |
| CE# | Chip Enable: When CE# is LOW, the device is enabled. Once |
| | the device starts a Program or Erase operation, the Chip Enable |
| | port can be de-asserted. In addition, CE# LOW activates |
| | and CE# HIGH deactivates the internal clock signals. |
| RST# | Chip Reset: RST# provides a reset for the device. When RST# |
| | is HIGH, the device is on the normal operating mode. When |
| | RST# is LOW, the device will enter the Reset mode. |
| D[n] | Data Input: (n = 1, 2, 3, 4, 5, 6, 7 or 8) receives command, |
| | address and input data. If the device is configured in ‘1-bit |
| | Link mode (=default)’, D1 is the only valid signal and |
| | receives one byte of packet in 8 crossings of CK/CK#. If the |
| | device is configured in ‘2-bit Link mode’, D1 & D2 are |
| | only valid signals and receive one byte of packet in 4 crossings |
| | of CK/CK#. Unused input ports are grounded. |
| Q[n] | Data Output: (n = 1, 2, 3, 4, 5, 6, 7 or 8) transmits output |
| | data during read operation. If device is configured in ‘1-bit |
| | Link mode (=default)’, Q1 is the only valid signal |
| | and transmits one byte of packet in 8 crossings of CK/CK#. |
| | If the device is configured in ‘2-bit Link mode’, Q1 & Q2 |
| | are the only valid signals and transmit one byte of packet in 4 |
| | crossings of CK/CK#. Unused output ports are DNC (=Do |
| | Not Connect). |
| CSI | Command Strobe Input: When CSI is HIGH, command, address |
| | and input data through D[n] are latched on the crossing of CK |
| | and CK#. When CSI is LOW, the device ignores input signals |
| | from D[n]. |
| CSO | Command Strobe Output: The echo signal CSO is a re-transmitted |
| | version of the source signal CSI. |
| DSI | Data Strobe Input: Enables the Q[n] buffer when HIGH. When DSI |
| | is LOW, the Q[n] buffer holds the previous data accessed. |
| DSO | Data Strobe Output: The echo signal DSO is a re-transmitted |
| | version of the source signal DSI. |

Having both the commonly available asynchronous flash memory devices of FIG. 1B and the serial interface flash memory devices of FIG. 2B allows a memory system manufacturer to provide both types of memory systems. However, this will likely introduce higher cost to the memory system manufacturer since two different types of memory devices must be sourced and purchased. Those skilled in the art understand that the price per memory device decreases when large quantities are purchased, hence large quantities are purchased to minimize the cost of the memory system. Therefore, while a manufacturer can provide both types of memory systems, it bears the risk of having one type of memory device fall out of market demand due the high market demand of the other. This may leave them with purchased supplies of a memory device that cannot be used. While the asynchronous NAND flash device of FIG. 1B is, at the present time, commonly used, it does not provide the performance benefits of the synchronous flash device of FIG. 2B. This situation may arise for non-flash memory devices as well, where two similar but interface incompatible devices having their own advantages are available for integration into a memory system.

At least some example embodiments provide a high performance composite memory device with a high-speed interface chip or a bridge device in conjunction with discrete memory devices, in a multi-chip package (MCP) or system in package (SIP). The bridge device provides an I/O interface with the system it is integrated within, and receives global memory control signals following a global format, and converts the commands into local memory control signals following a native or local format compatible with the discrete memory devices. The bridge device thereby allows for re-use of discrete memory devices, such as NAND flash devices, while providing the performance benefits afforded by the I/O interface of the bridge device. The bridge device can be embodied as a discrete logic die integrated with the discrete memory device dies in the package.

In the present examples, the global format is a serial data format compatible with the serial flash memory device of FIGS. 2A and 2B, and the local format is a parallel data format compatible with the asynchronous flash memory device of FIGS. 1A and 2B. However, the embodiments of the present invention are not limited to the above example formats, as any pair of memory control signal formats can be used, depending the type of discrete memory devices used in the composite memory device and the type of memory system the composite memory device is used within. For example, the global format of the memory system can follow the Open NAND Flash Interface (ONFi) standard, and the local format can follow the asynchronous flash memory device memory control signal format. For example, one specific ONFi standard is the ONFi 2.0 Specification. Alternatively, the global format can follow the asynchronous flash memory device memory control signal format and the local format can follow the ONFi 2.0 Specification format. In general, the ONFi specification is a multi-drop synchronous protocol where data and commands are provided to the compliant memory device via its data input/output ports synchronously with a clock. In otherwords, an ONFi compliant memory device can have some similarities to an asynchronous NAND flash memory device having parallel bi-directional input/output ports with one difference being that the ONFi compliant device receives a clock signal.

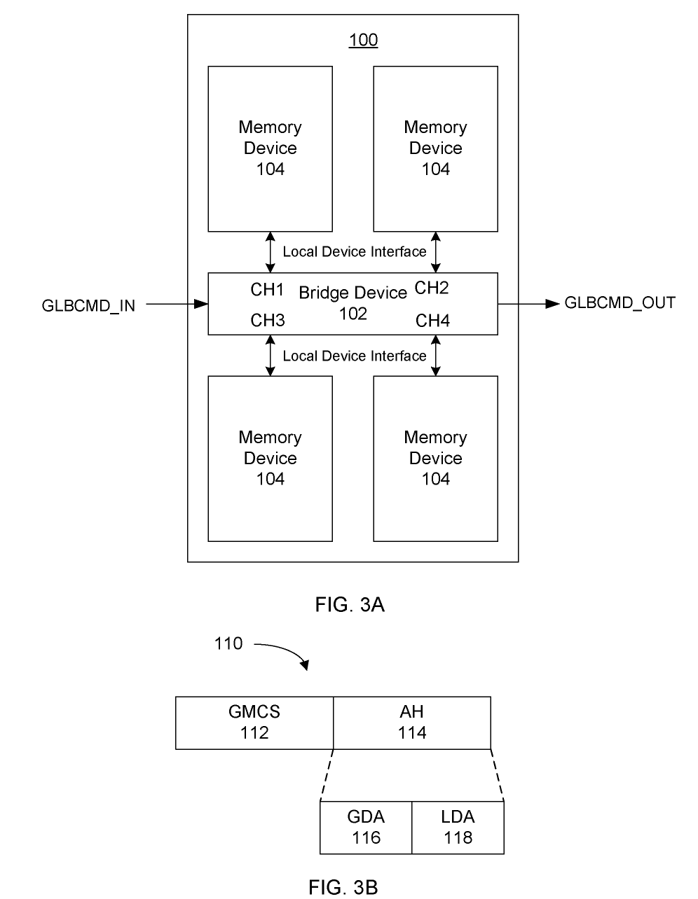

FIG. 3A is a block diagram of a composite memory device, according to a present embodiment. As shown in FIG. 3A, composite memory device 100 includes a bridge device 102 connected to four discrete memory devices 104. The bridge device 102 is also referred to as a bridge chip in some embodiments, as it is fabricated as a discrete chip. Each of the discrete memory devices 104 can be asynchronous flash memory devices having a memory capacity of 8 Gb, for example, but any capacity discrete flash memory device can be used instead of 8 Gb devices. Furthermore, composite memory device 100 is not limited to having four discrete memory devices. Any suitable number of discrete memory devices can be included, when bridge device 102 is designed to accommodate the maximum number of discrete memory devices in the composite memory device 100. In the presently shown embodiment, the bridge device 102 has four dedicated channels, CH1, CH2, CH3 and CH4, each associated with one discrete memory device 104. Each channel includes the I/O and control signals necessary for controlling the discrete memory device 104.

Composite memory device 100 has an input port GLBCMD_IN for receiving a global command, and an output port GLBCMD_OUT for passing the received global command and read data. FIG. 3B is a schematic illustrating the hierarchy of a global command, according to a present embodiment. The global command 110 includes global memory control signals (GMCS) 112 having a specific format, and an address header (AH) 114. These global memory control signals 112 provide a memory command and command signals, such as the memory control signals for the serial interface flash memory device of FIG. 2B. The address header 114 includes addressing information used at the system level and the composite memory device level. This additional addressing information includes a global device address (GDA) 116 for selecting a composite memory device to execute an op code in the memory command, and a local device address (LDA) 118 for selecting a particular discrete device within the selected composite memory device to execute the op code. In summary, the global command includes all the memory control signals corresponding to one format, and further addressing information which may be required for selecting or controlling the composite memory device or the discrete memory devices therein.

It is noted that bridge device 102 does not execute the op code or access any memory location with the row and address information. The bridge device 102 uses the global device address 116 to determine if it is selected to convert the received global memory control signals 112. If selected, bridge device 102 then uses the local device address 118 to determine which of the discrete memory devices the converted global memory control signals 112 is sent to. In order to communicate with all four discrete memory devices 104, bridge device 102 includes four sets of local I/O ports, one set in each of channels CH1, CH2, CH3 and CH4, each connected to a corresponding discrete memory device. As previously mentioned, each set of local I/O ports includes all the signals that the discrete memory device requires for proper operation, and thereby functions as a local device interface.

Read data is provided by any one of a flash memory device 104 from composite memory device 100, or from a previous composite memory device. In particular, the bridge device 102 can be connected to a memory controller of a memory system, or to another bridge device of another composite memory device in a system of serially interconnected devices. The input port GLBCMD_IN and output port GLBCMD_OUT can be package pins, other physical conductors, or any other circuits for transmitting/receiving the global command signals and read data to and from the composite memory device 100, and in particular, to and from bridge device 102. The bridge device 102 therefore has corresponding connections to the input port GLBCMD_IN and the output port GLBCMD_OUT to enable communication with an external controller, such as memory controller 22 of FIG. 2A, or with the bridge devices from other composite memory devices in the system. Commonly owned PCT patent publication number WO2010/043032 describes in detail how many composite memory devices can be connected serially to each other in a memory system that provides improved performance and storage capacity relative to the previously shown memory systems of FIG. 1A and FIG. 2A. PCT patent publication number WO2010/043032 describes additional details of bridge device 102, therefore only the features and functions relevant to the presently described embodiments are described later.

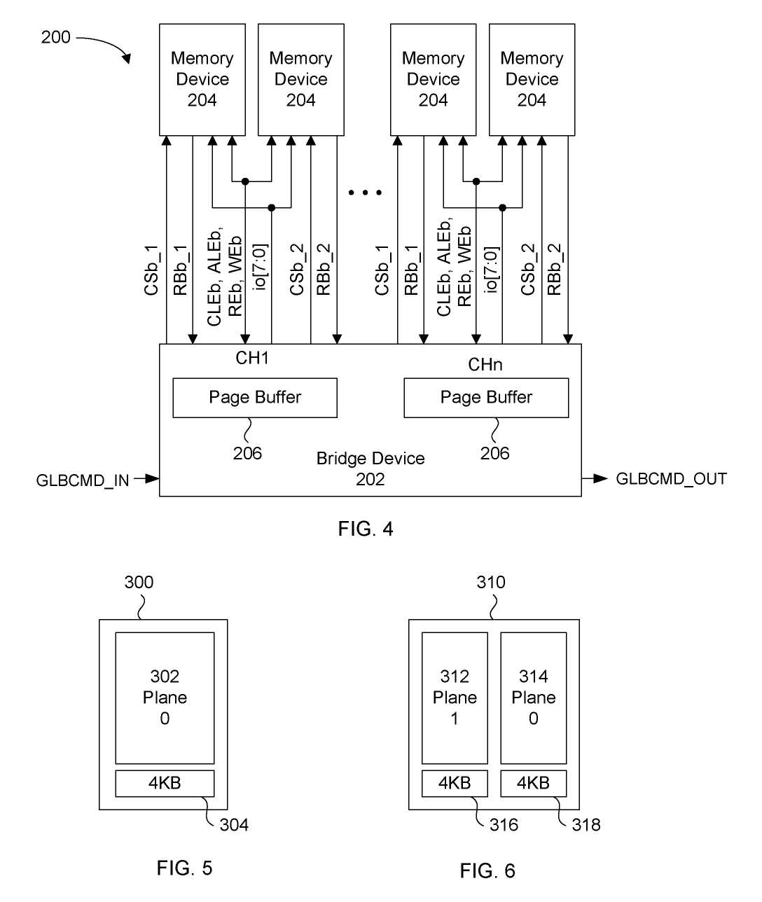

While the composite memory device 100 shown in the embodiment of FIG. 3A has one discrete memory device 104 connected to one channel of the bridge device 102, the bridge device can be configured for connecting to memory devices or more to each channel to further increase the total memory capacity of the composite memory device. FIG. 4 is a block diagram of another composite memory device, according to a present embodiment. Composite memory device 200 includes a bridge device 202 having a plurality of channels CH1 to CHn, where CHn is a last channel of bridge device 202. In the presently shown embodiment, each channel has two memory devices 204 connected to it. As shown in FIG. 4, a pair of memory devices 204 associated with one channel share a common set of control signals CLEb, ALEb, REb, WEb, and a common set of input/output lines io[7:0]. Each memory device 204 associated with one channel receives its own chip select signal and provides its own ready/busy signal. As shown in FIG. 4, one memory device 204 connected to CH1 receives chip select signal CSb_1 and provides its own ready/busy signal RBb_1. It is noted that the “b” designates the signal to be an active low logical level signal.

Each channel of bridge device 202 has a data storage unit, such as a dedicated data buffer 206 or a designated portion of a memory, for receiving and storing a correspondingly sized unit of data from either of the two memory devices 204 connected to the channel. The dedicated data buffer 206 is not shared between channels. A unit of data provided by a memory device 204 can be a page of data for example, or any maximum amount of data which can be accessed with one logical row address in a read operation. In flash memory devices, such as memory devices 204 in the present embodiments, a read operation results in a page of data stored in the memory array being read out and transferred to an internal page buffer. In response to a command received by the flash memory device 204, up to the entire contents of the internal page buffer is output as read data. It is noted that some memory devices are configured for reading out two or more pages of data in a read operation. This is explained further with reference to FIG. 5 and FIG. 6.

FIG. 5 and FIG. 6 are block diagrams showing different plane and corresponding page buffer configurations which are possible for memory device 204 of you FIG. 5. FIG. 5 is a general block diagram showing a typical flash memory device configured to have a single plane. Flash memory device 300 includes a single plane 302 and a single page buffer 304. Plane 302 includes a memory array consisting of memory cells connected to wordlines and bitlines, where the word lines extend horizontally from the left side to the right side of plane 302 and the bit lines extend vertically from the top to the bottom of plane 302. Wordline drivers (not shown) drive a selected wordline during a read operation, and bitline sense amplifier circuits (not shown) determine stored logic states of the cells connected to the selected wordline by sensing their respective bitlines. This sensed data is stored in page buffer 304. In the present example of FIG. 5, a page of data is 4 KB.

FIG. 6 is a general block diagram showing a multi-plane flash memory device. Flash memory device 310 includes a first plane 312 and a second plane 314, each having associated first page buffer 316 and second page buffer 318. Flash memory device 310 is not limited to having 2 planes, and thus can have any number of planes. Planes 312 and 314 each have their own bitlines and wordlines, and may each have logically identical wordline circuits. This means that for any single row address, a wordline in plane 312 and a wordline in plane 314 are driven at the same time to access the memory cells connected thereto. Therefore, page buffers 316 and 318 store the pages of data read out from planes 312 and 314 respectively.

Returning to FIG. 4, when one or both of memory devices 204 connected to one channel has received a read command issued by bridge device 202, the memory device(s) 204 initiates internal read operations and eventually loads its internal page buffer, or page buffers in the case of a multi plane memory, with the page of read data from the memory array. The bridge device 202 will then issue a data transfer command to one or both memory devices 204, which respond by outputting the contents of their page buffers to the data buffer 206 of bridge device 202. Once this transfer has been completed, which device 202 will read out the data stored in data buffer 206 and output it via the GLBCMD_OUT output port.

The data buffers 206 of bridge device 202 can be sized to store any number of pages of data received from the memory devices 204 associated with the channel. For example, if the pair of memory devices 204 connected to channel CH1 are each configured to have 2 planes as shown in FIG. 6, then the amount of data buffering per channel would be (2 planes)×(2 memory devices)=4 pages of buffer capacity. However, this could result in a die cost increase for the bridge device that could render a chip with limited commercial value. This is due to the fact that the total area of the die is mainly driven by the memory used for storing the pages of data from the memory devices 204. From a cost perspective, the minimum amount of buffering is desirable, namely memory with only one page capacity per channel.

Such a configuration is suitable for the bridge device 102 of composite memory device 100 shown in FIG. 3A which has exactly one memory device 104 connected to one channel, provided each memory device 104 is a single plane device such as the flash memory device 300 of FIG. 5. In such a configuration, each memory device 104 has dedicated access to a data buffer of the bridge device. However, a bridge device having a single page capacity for a channel serving multiple page sources connected to the channel can arise result in a storage conflict. A page source can be the page buffer from a single plane memory device, or each individual page buffer for respective planes in a multi-plane memory device.

To illustrate this storage conflict when the bridge device channel data buffer capacity is less than the combined page source capacity, first consider how a page read is performed by the bridge device. When performing a page read command, the bridge device automatically transfers the read data from the memory device to the onboard data buffer once the memory device has retrieved the read data from its memory array. The bridge device then updates its status register to ‘Ready’ indicating to the memory controller that the requested read data is ready to be driven out. However, with more than one memory device connected to a given channel, or a memory device capable of simultaneously accessing a page on each of two planes, it is desirable to simultaneously issue as many concurrent page operations as the memory devices can support in order to hide any internal latency, thereby improving the overall bandwidth of the memory system. When a page read has been issued concurrently to more than one memory device or a memory device with multiple page buffers, and with less than the ideal data buffer capacity on the bridge device, there arises a conflict such as to where to store all of the read data.

To illustrate by example, when 2 single plane memory devices connected to one channel have completed their internal array access to retrieve the read data from the addressed pages, the bridge device should automatically transfer the data to its onboard data buffer associated with the channel. If there is not enough capacity to store all the data, then some data could potentially be lost.

Therefore, an arbitration method has been developed to resolve the storage space conflict which allows internal memory device read latencies to be over-lapped, as desired, and by scheduling the transfer of read data from the flash memory devices to the bridge device data buffer based on flash completion order, priority, and command sequencing. According to the present embodiments, status registers of the bridge device are used for the arbitration method.

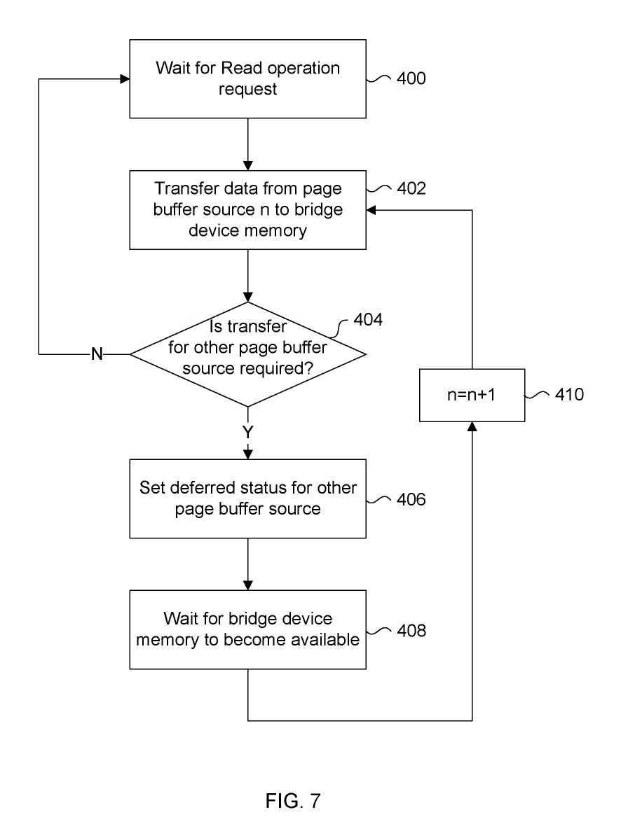

FIG. 7 is a flow chart of a general method for transferring pages of data from multiple sources to a limited memory space in a device such as the previously described bridge device of FIG. 3A and FIG. 4, according to a present embodiment. The method of FIG. 7 is executed by control logic of the bridge device for one channel connected to either a single memory device having multiple planes, or multiple memory devices each having a single plane or multiple planes. For the present method, a memory device having a single plane is considered a page buffer source, and each plane of a multiplane memory device is considered a page buffer source.

The method starts at step 400 where the bridge device receives requests to read data from at least 2 different page buffer sources connected to one channel. The requests may arrive at the bridge chip at the same time or one after the other, and corresponding read commands are issued to the memory devices. In order to take advantage of the read latency of flash memory devices, such read commands are typically issued in rapid succession. Eventually, a first page buffer source is ready to transfer its page of data to the bridge device, and it signals the bridge device of its ready status. This first page buffer source is now referred to as page buffer source n. At this time, the other page buffer sources may not be ready to transfer their respective pages of data yet. At step 402, the bridge device instructs page buffer source n to transfer the stored read data to the bridge device page buffer. At step 404, the bridge device checks to see if there are read operations pending for at least one other page buffer source connected to the channel, indicating that a data transfer to the same data buffer is imminent. If there are no other read operations pending for at least one other page buffer source, then the method returns to step 400, and the bridge device data buffer is eventually filled with the read data from page buffer source n. On the other hand, if there is one other pending read operation for another page buffer source, then a deferred data transfer status is set for the other page buffer sources at step 406. It is assumed in the present example there are only two page buffer sources connected to the channel.

Now that the other page buffer source, referred to as page buffer source n+1, is set to the deferred status by the bridge device, the bridge device is inhibited from requesting data transfer from page buffer source n+1 to its data buffer while the data buffer is in use. As will be described later, this enables the bridge device to ignore any ready status issued by the other page buffer source n+1 that would have otherwise triggered the bridge device to issue a data transfer command to page buffer source n+1. The data buffer being in use can mean it is being filled with data transferred from page buffer source n, or that the data buffer is in the process of outputting its contents to the host system or memory controller. In either case, the data buffer is unavailable for receiving read data from another page buffer source.

At step 408, the bridge device waits for the data buffer of the channel to become available, and when it does, the value n is incremented at 410 to access the next page buffer source n+1. The method then returns to step 402 and the bridge device issues a data transfer command to page buffer source n+1 which is ready to provide its page of data.

In summary, the bridge device can determine the first page buffer source that is ready, while keeping track of the other page buffer source(s) which have pending read operations for the purpose of deferring their data transfer operations until the data buffer associated with the channel is available. In embodiments where there are multiple page buffer sources connected to the channel and all are ready to transfer their data, the bridge device can be configured with any number and combination of prioritization schemes in order to determine which specific page buffer source is next. Example prioritization schemes include one based on order of arrival, another can be importance of transactions, and yet another can be based on address ranges. Any prioritization scheme can be used with the presently described methods.

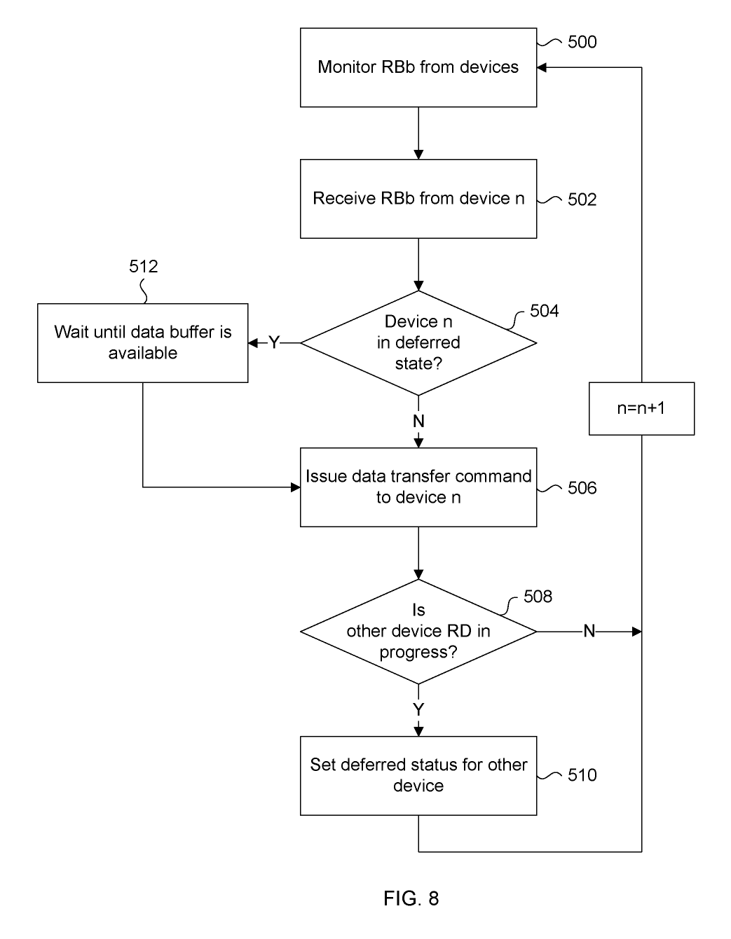

FIG. 8 is a flow chart of a method for arbitrating transfer of a page of data from multiple flash devices connected to one channel, to a data buffer of the bridge device associated with the channel using only a ready/busy status signal, according to a present embodiment. The method of FIG. 8 assumes that each memory device connected to the channel provides a signal indicating its ready/busy status, such as signals RBb_1 and RBb_2 provided by the memory devices 204 connected to channel CH1 of FIG. 4. While the present embodiments use flash memory devices having a dedicated ready/busy signal, any combination of a number of signals can be used by a device to indicate its read/busy status provided the bridge device is configured to interpret such signal combinations. It is assumed that the bridge device has issued read commands to at least two memory devices connected to one channel.

The method begins at step 500 where the bridge device monitors the ready/busy status signals (egg. RBb_1 and RBb_2) from all the devices connected to the channel. At step 502, a memory devices drives its ready/busy status signal to an active logic state, indicating to the bridge device that the corresponding memory device has completed internal read operations and its page buffer now stores read data from the memory array. It is assumed that this memory device is the first ready memory device, and is now referred to as device n. The bridge device now checks if device n has been set to a deferred state. Since it is the first device to be ready in the present example, the method proceeds to step 506 where the bridge device issues a data transfer command to device n. In response to the data transfer command, the memory device begins outputting the contents of its page buffer, which is received and stored in the data register of the bridge device. Proceeding to step 508, the bridge device checks if read commands have been issued to any other memory devices. As will be described later in further detail, the bridge device keeps track of the read commands it has issued to each memory device. If the bridge device determines there is at least one other memory device that has received a read command, it then sets a deferred status for each of these memory devices at step 510. In the present example, it is assumed that device n+1 is on such memory device, and the bridge device sets a deferred status for it. On the other hand, if no other read commands have been issued and device n is the only memory device connected to the channel which received a read command, then the method returns to step 500. Returning to step 510, the method returns to step 500 after the deferred status is set for the appropriate memory devices.

Returning to step 500, the bridge device waits for the ready/busy status signal for the next device to be ready, which in the example would be device n+1. It is eventually received at step 502 and the bridge device checks at step 504 if device n+1 is in the deferred state. Because device n+1 was previously set to the deferred state by the bridge device, the method then proceeds to step 512 where the bridge device waits for the data buffer of the channel to become available. In one embodiment, the memory controller queries the bridge device to check the status of the internal data transfer operations between the bridge device and the memory device. In another embodiment, the bridge device could issue its own ready/busy signal to the memory controller to indicate that the internal data transfer operation for that channel has been completed. In either case, the memory controller can issue a command to reinitiate the page read operation for memory device n+1 when it has received an indication that the internal data transfer operation for device n has been completed. Once the data buffer has become available, the bridge device then issues a data transfer command to device n+1 to initiate data transfer from the page buffer of device n+1 to the data buffer of the bridge device. If there are no other memory devices that received read commands, then the method returns to step 500, thereby ending the data transfer arbitration method for the channel.

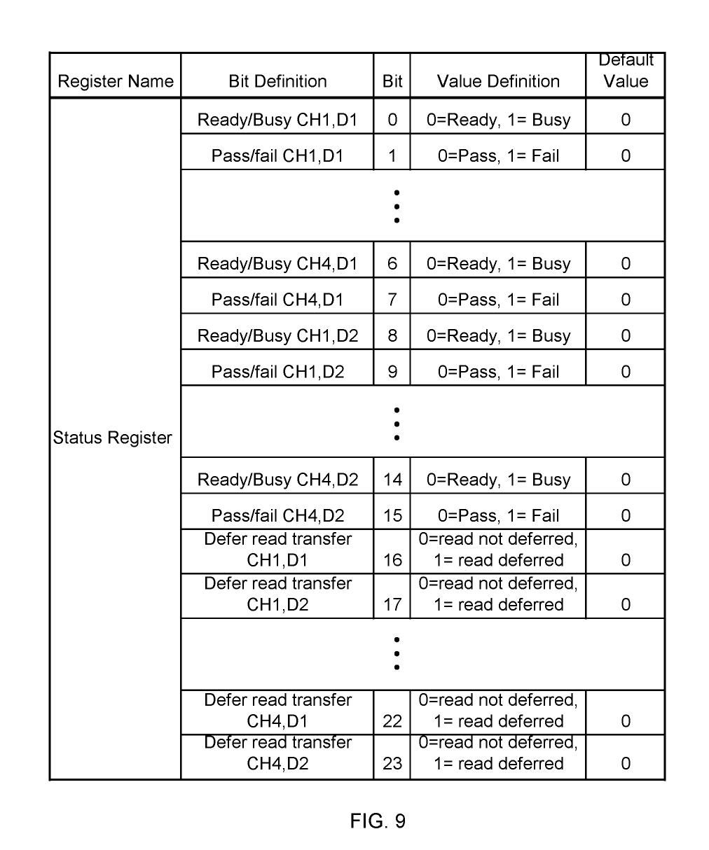

The presently described bridge device embodiment can arbitrate data transfers from any number of memory devices connected to a single channel by including status register bits that record status information of each memory device connected to the channel. FIG. 9 is a status register definition table for a bridge device, according to a present embodiment. The status register of FIG. 9 is configured for a bridge device having 4 channels (egg. CH1, CH2, CH3 and CH4), where each channel has two memory devices connected to it in a parallel configuration. For each memory device, the status register stores its ready/busy status, its pass/fail status, and its deferred read transfer status. The naming convention used in the table of FIG. 9 is as follows. The ready/busy status bit is labeled “Ready/Busy CH[i],D[j]”, the pass/fail status bit is labeled “Pass/fail CH[i],D[j]”, and the deferred status bit is labeled “Defer read transfer CH[i],D[j]”, where i represents the channel number of the bridge device, and j represents the device number connected to channel i. The number of status bits can scaled according to the number of channels present in the bridge device, and the maximum number of memory devices which can be connected to each channel. The bridge device can therefore keep track of the status of each memory device, as well as the deferred status of each memory device, for the purposes of arbitrating read data transfers from the memory devices to the data buffer of the channel the memory devices are connected to.

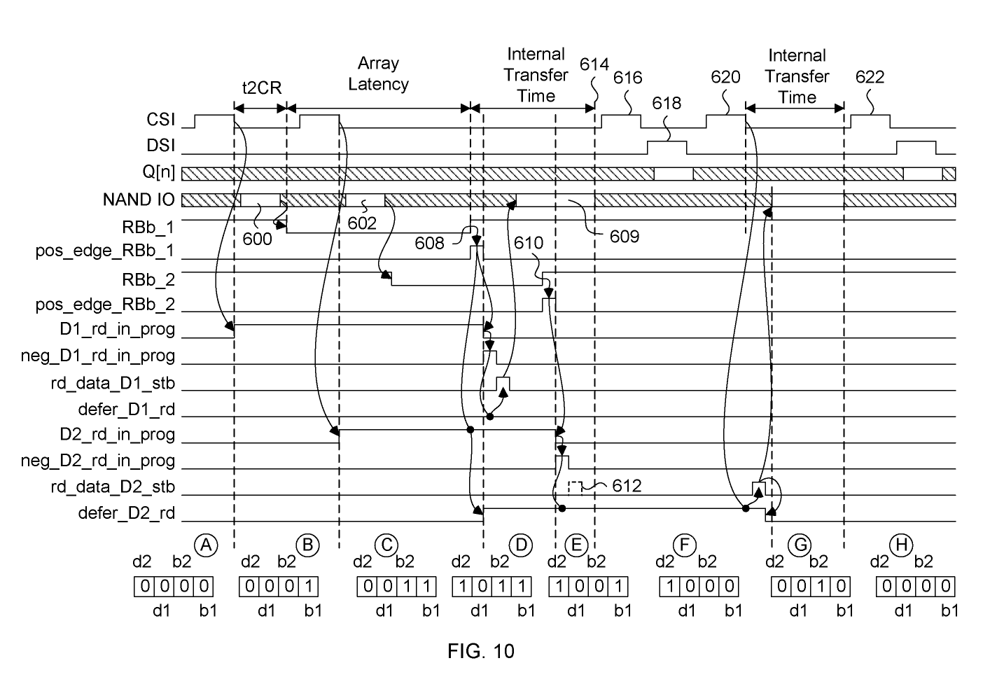

FIG. 10 is a sequence diagram illustrating an example read transfer operation from two flash devices connected to a channel to a data buffer of the bridge device, according to a present embodiment. This example sequence diagram illustrates how the bridge device responds to ready/busy signals issued by the memory devices in order to arbitrate read transfer operations and avoid conflicting use of the data buffer by both memory devices. It is noted that the bridge controller has logic for automatically issuing a data transfer command to memory devices which report having their read data ready in their respective page buffers after receiving a read command. According to the present embodiments, the bridge device includes arbitration logic for dealing with the situation when a second memory device reports it is ready while the data buffer of the channel is being used to receive read data from a first memory device, or while it is outputting the stored read data to an external device.

The sequence diagram of FIG. 10 shows signal traces for internal and external signals, which are described as follows. The bridge device receives an external command strobe signal CSI and an external data strobe signal DSI, provided by a memory controller or host device, both of which have been previously described in Table 2. The bridge device outputs read data stored in the data buffers of the channels through its Q[n] output port, also previously described in Table 2. Within the bridge device, there is a memory device interface which provides command and data information to the memory devices in format compatible with the memory devices. In the present example the memory devices are NAND flash devices, so a bidirectional “NAND IO” port is shown in FIG. 10. The memory device interface of the bridge device further receives ready/busy signals RBb_1 and RBb_2 from device 1 and device 2 respectively. Internal control signal pos_edge_RBb_1 is a pulsed signal generated in response to detection of memory device 1 being ready to transfer read data from its page buffer. In the present example, the pulse is generated in response to detection of RBb_1 transitioning from the low logic state to the high logic state, which indicates that the memory device internal read operation is complete. Internal control signal pos_edge_RBb_2 is the same type of signal, but responsive to RBb_2.

Internal signal D1_rd_in_prog is a status signal set by the bridge device when a read operation is issued to device 1. Internal signal neg_D1_rd_in_prog is pulsed in response to a falling edge of D1_rd_in_prog. Internal signal rd_data_D1_stb is a pulsed signal generated only when the neg_D1_rd_in_prog pulse is detected and deferred status signal defer_D1_rd is in the inactive state. When rd_data_D1_stb is pulsed, a read transfer command is issued to memory device 1 to initiate transfer of its page buffer data to the data buffer associated with the channel of the bridge device. The status signal defer_D1_rd can be derived from the status register. The remaining internal signals D2_rd_in_prog, neg_D2_rd_in_prog, rd_data_D2_stb and defer_D2_rd, function in the same was as their respective D1 counterpart signals, but are associated with memory device 2. A description of the sequence diagram now follows, and it is noted that the time periods are not shown to scale. At the bottom of FIG. 10 are the logic states of status register bits d1, d2, b1 and b2. Bits d1 and d2 represents the deferred status for memory devices D1 and D2 respectively, and bits b1 and b2 represents the ready/busy status for memory devices D1 and D2 respectively.

The host controller, such as a memory controller, may begin a 2-device read operation after it has determined that the target devices in the target channel are ‘Ready’, as shown at ‘A’, by reading the status bits. At ‘A’, both status bits b1 and b2 are logic 0, indicating that both memory devices D1 and D2 are ready. The first step is for the memory controller to issue two ‘page read’ commands where read command 600 is addressed device 1 and read command 602 is addressed to device 2. The bridge converts these commands into commands understood by the flash memory devices and issues them to the appropriate memory devices. After the bridge device decodes each of the read commands, it sets the corresponding Ready/Busy bit to 1, as shown at ‘B’ and ‘C’, and sets D1_rd_in_progress and D2_rd_in_progress to the high logic state to keep track of read commands that are currently in progress. After the memory devices have accepted their respective read commands, memory device 1 and 2 drives its RBb_1 and RBb_2 lines to a logic ‘0’ level, shown 604 and 606 respectively, indicating to the bridge device that they are busy with their respective read operations.

Since it takes some time for the bridge device to process each read command, issue the corresponding command to the target memory device and wait for that memory device to accept the command, the controller must wait a predefined separation latency period t2CR before issuing the second of the pair of read commands 602 so that the bridge device can finish processing the first read command 600. The controller is free to wait longer before issuing the second read command 602 but, generally, should issue it well in advance of the expiration of the first memory device's read time tR. Otherwise the bridge device's internal bus will be busy transferring data from the first memory device D1 to the bridge device and the bridge device could suffer a malfunction.

The memory devices are busy for a time period as defined in the manufacturer's specification of the particular devices being used, and may be denoted as tR. In FIG. 10 that time period is labeled as ‘Array latency’ for memory device D1. The array latency differs from manufacturer to manufacturer, from device to device, and may change as the device ages. When the array latency expires for each memory device, it releases its ready/busy signal (eg. RBb_1), which returns to logic value ‘1’, signaling to the bridge device that the read data is available in its page buffer. As shown at 608 and 610, RBb_1 and RBb_2 rise to a logic ‘1’.

During a ‘normal’ single memory device read operation, the bridge device automatically issues a ‘data read’ command to the flash to transfer the read data from the memory device to the bridge device's data buffer following the rising edge of RBb. According to the present embodiment, extra control signals are used that allow for the scheduling of the transfer of the auto-read transfer during two-device (or multi-device) read operations. For two-device reads, the rising edge of the RBb causes the bridge device to de-assert rd_in_progress for that memory device. In the presently shown example, strobe signal rd_data_D1_stb is generated in response to RBb_1 rising to the logic 1 level. The strobe signal rd_data_D1_stb is the trigger for issuing the ‘read data’ command for memory device D1. This strobe is generated provided that the memory interface I/O bus is not busy transferring data from other device(s) connected to the bus of the channel. A mechanism for arbitrating this strobe is described below.

The provided example embodiments use logic-generated strobes to indicate when a signal of interest has made a positive edge transition from logic 0 to 1 or a negative edge transition from logic 1 to 0 but other techniques may be possible. The main concept in the present embodiments is that the edge is detected and used to trigger a subsequent logic event.

Since the two ready/busy signals RBb_1 and RBb_2 may go high close enough together that the data for the first memory device has not yet finished being transferred to the data buffer of the bridge device, there may be contention between the two pages of data for access to the data buffer of the bridge device. To solve this problem, a second set of control bits are provided that are used to defer the automatic read data transfer for the memory device that finishes later. In FIG. 10, these are called defer_D1_rd and defer_D2_rd. In this example RBb_1 goes high first at 608. This causes D1_rd_in_progress to go low (via strobe signal pos_edge_RBb_1) and defer_D2_rd to go high. Defer_D2_rd is asserted because memory device 1 finished its read, as indicated by the positive edge on RBb_1, while memory device 2 is still busy with its page read, as indicated with chp2_rd_in_progress=‘1’. The equation for determining when to defer a memory device's auto transfer of read data is given as Equation 1 below.

(Positive edge of defer_{—}Dj_rd)=pos_edge_RBbi&&Dj_rd_in_progress

The falling edge of D1_rd_in_progress triggers a strobe rd_data_D1_stb to be generated via neg_edge_D1_rd_in_prog, provided that defer_D1_rd is not high. This strobe causes the bridge device to begin transferring the read data from device 1 (D1) to the bridge device's data buffer. The NAND IO is shown at 609 to be carrying valid data from the page buffer of memory device D1 to the data buffer of the bridge device. The rising edge of defer_D2_rd causes the status register to log the read operation for memory device 2 as having been deferred as shown in interval ‘D’ where status bit d2 is set to the logic 1 state.

Later, at 610, memory device D2 becomes ‘Ready’ and de-asserts RBb_2, causing the D2_rd_in_progress in the bridge device to go low, thereby signaling the end of that memory device's page read process. Since defer_D2_rd is high at this time, the automatic transferring of the read data to the data buffer is deferred until a later time. In other words, defer_D2_rd being high prevents the generation of rd_data_D2_stb. As shown at 612, the rd_data_D2_stb strobe signal is shown in dashed lines, indicating where the strobe would have occurred if memory device D2 was not in the deferred state. The status register then changes status bit b2 to a logic 0 to reflect the fact that memory device D2 has become ‘Ready’ but that it is deferred, as shown in interval ‘E’.

Eventually, the data transfer from memory device D1 to the data buffer of the bridge device is completed at the end of the first “Internal Transfer Time” period, labeled with reference numeral 614. The bridge device then changes status bit b1 to a logic 0 to indicate that it is now ready, and in particular that the data transfer operation is finished. Now the memory controller reads out the status register of the bridge device to determine the status of the internal operations.

The status register may be read at any time, and in this particular operation the memory controller is looking for one of the devices to be ‘Ready’ and not in the deferred status before it can proceed to transferring out data. The status read operation is not shown in the diagram but the value the controller would read is shown in interval ‘F’. The memory controller is aware of what transactions it has outstanding so this status register value tells the memory controller that the read from memory device D1 is complete and the data is available in the data buffer. The status value also tells the memory controller that the read command sent to memory device D2 has also completed but that the data transfer to the data buffer has been deferred and requires further action to retrieve. The memory controller then proceeds to issue a burst read command, which is indicated by CSI strobed to the 1 logic level at 616. The data of memory device D1 stored in the data buffer is then read out of the bridge device with a read packet indicated by DSI strobed to the 1 logic level at 618. As shown in FIG. 10, the Qn output port provides valid data.

After the memory controller has finished reading out the data from memory device D1, it is free to read the data from memory device D2. To do this it re-issues the original page read command to the same page in memory device D2, via another CSI strobe 620 with corresponding command (not shown). Since the page of data is still stored in the page buffer of memory device D2, and the bridge device auto-transfer operation was deferred, the bridge device simply reads out the data from the page buffer of memory device D2 into its data buffer by issuing a rd_data_D2_stb strobe at 622 in response to the re-issued page read command, making it available for the memory controller to later retrieve. During this time the status register indicates that memory device D2 is ‘Busy’ by setting status bit b2 to logic 1, but no longer in the deferred state as defer_D2_rd is set to the non-deferred 0 logic state, also shown in interval ‘G’ with status bit d2 at the logic 0 state. Once the data transfer from memory device D2 to the bridge device is completed, the status register value is updated to indicate that memory device D2 is ‘Ready’, as shown in interval ‘H’ with status bit b2 set back to logic 0. The memory controller is designed to know approximately how long to wait before checking to see if the internal bridge device data transfer operation is completed since this data is provided by the flash manufacturers and included with the bridge device specification. After the second “Internal Transfer Time” has elapsed, the memory controller reads the status register to confirm that memory device D2 is ‘Ready’ and that its data is available, and then proceeds to issue another burst read command at 622, and the data is output on the Qn output port in response to the subsequent DSI strobe.

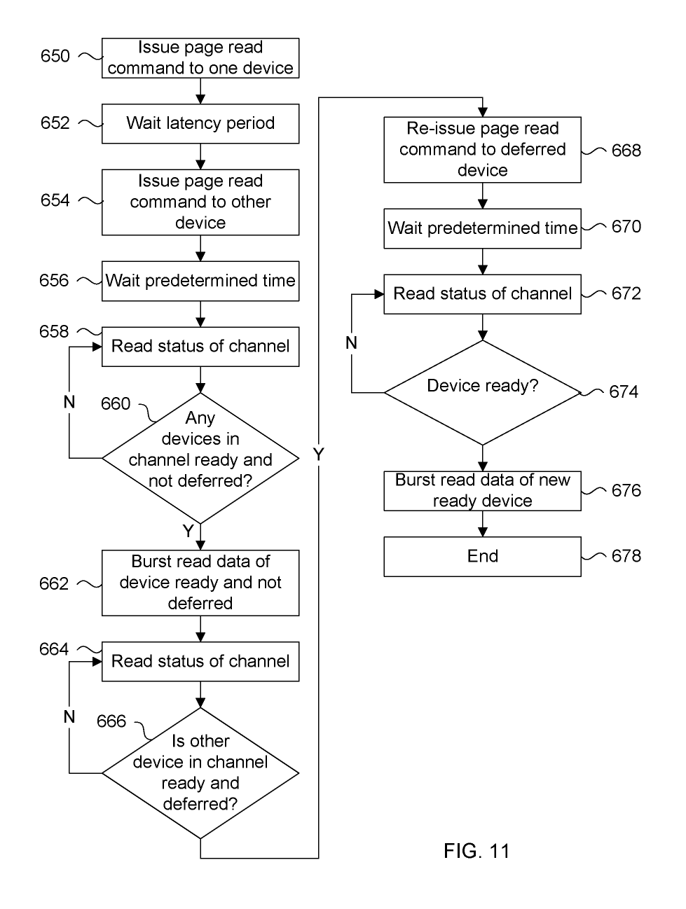

The method of FIG. 8 describes data transfer arbitration from the perspective of a bridge device. Following FIG. 11 the sequence of operations executed by the memory controller for reading to pages of data corresponding to one channel of the bridge device. The memory controller starts the operation at step 650 by issuing a page read command to one device connected to the channel of the bridge device. The memory controller then waits a predetermined latency at step 652 before issuing another page read command to the other memory device connected to the channel at step 654. At step 656, the memory controller waits for a predetermined time to elapse, before reading the status register of the bridge device at step 658, and in particular for the channel. By example, this predetermined time can be set by an internal timer within the memory controller, or alternately, the bridge device can issue a strobe signal to the memory controller to indicate that it is time to check the status register since a read or program operation has completed. In either case, the memory controller waits for a predetermined time before reading the status register of the bridge device. A determination is made at step 660 based on the read out bits of the status register to check if any of the devices connected to the channel are ready and not deferred. If the determination is false, then the method returns to step 658. Otherwise, a memory device connected to the channel has completed transfer of its page buffer contents to the data buffer of the bridge device. The method then proceeds to step 662, where the memory controller issues a burst read command to read out the data stored in the data buffer of the bridge device.

The memory controller requests the status of the channel from the bridge device again at step 664, and based on the status bits write out, the memory controller determines if the other device connected to the channel is ready and deferred at step 666. Once again, if either condition is false, the method returns to step 664. Otherwise, the method proceeds to step 668, where the memory controller reissues a page read command to the deferred device. Within the bridge device, a data transfer operation is initiated to transfer the data stored in the page buffer of the memory device to the data buffer of the bridge device. At step 670, the memory controller waits for its internal read timer to elapse before reading the status of the channel at step 672. If the status register indicates that this other device is not ready at step 674, then the method returns to step 672. Otherwise, the page of data is now stored in the data buffer of the bridge device, and the memory controller issues a burst read command to read out the contents of the data buffer at step 676. The method then ends at step 678, if there are no further memory devices connected to the channel. The presently described example assumes that there are only 2 memory devices connected to the channel. In an alternate embodiment, if there were more than 2 memory devices connect to the channel and the memory controller issues page read commands to each of them, then the method would not end at step 678, but would instead return to step 664 for reading out data from the next memory device.

With reference to FIG. 10, step 650, 652 and 654 corresponds to the first 2 CSI strobes where the controller first issues a page read command to one device in the channel, waits a predefined separation latency period t2CR and then issues a read to the second device in the same channel.

Steps 616, 658, 660 and 662 corresponds to events occurring after the CSI strobe and up to the third CSI strobe. After the memory controller has issued the read commands it sets its internal timer, if it is equipped with one, and wait for it to elapse before reading the bridge device status register to determine which, if any, of the target memory devices are ‘Ready’ with data to be transmitted out of the bridge device. If the controller is not equipped with an internal read timer, it may poll the status register at intervals or have some other means of determining when to check the bridge device status register. When one of the memory devices is determined to be ‘Ready’ by information in the status register, the memory controller issues the Burst Read command to the its device followed by the read packet (DSI=1) in order to transmit the read data from the ‘Ready’ memory device out so that it may be returned to the memory controller.

Steps 664, 666 and 668 corresponds to events occurring at the 4th CSI strobe. The memory controller polls or otherwise checks the bridge device status register until the second memory device is ‘Ready’ but ‘Deferred’. The memory controller then re-issues the original page read command that it sent to this memory device causing the bridge device to read the data from the page buffer into the bridge device data buffer.

Steps 670, 672, 674 and 676 corresponds to events occurring after the fourth CSI strobe and after the fifth CSI strobe. After re-issuing the read command to the deferred device, the memory controller waits for it's read timer to elapse, indicating the end of the Internal Transfer Time, then polls the status register until the deferred memory device is ‘Ready’ and not ‘Deferred’. Again, there may be an alternate preferred method for determining when to read the status register but that is up to the memory controller designer. Once the desired status is read, the memory controller issues a Burst Read command for the data followed by the read packet to transmit the data back to the controller.

The previously described embodiments easily handle the situation where one device clearly becomes ready before a second device connected to the same channel becomes ready. There can be the situation where both memory devices connected to the same channel become ready at the same time, by virtue of their respective ready/busy signals RBb being asserted at the same time. In this situation, bridge device can be preprogrammed or hardwired to prioritize one memory device over the other. Alternately, the priority can be dynamically set. For example, an additional bit could be provided that is controlled by means of a programmable register. If the register is programmed with logic 0 for example, memory device 1 will be given priority. If the register is programmed with logic 1 for example, memory device 2 will be given priority. Any other techniques for prioritizing one memory device over another, or for prioritizing each memory device of a series of memory devices, can be used.

The previously described method of FIG. 8, and the example 2 memory device data read operation of FIG. 10 are specific example embodiments of the arbitration method shown in FIG. 7. While the method of FIG. 8 is directed to arbitrating between 2 memory devices each having a single page buffer of data to output in any single read operation, each of the memory devices can be multiplane devices each having at least 2 page buffers of data to output in any single read operation.

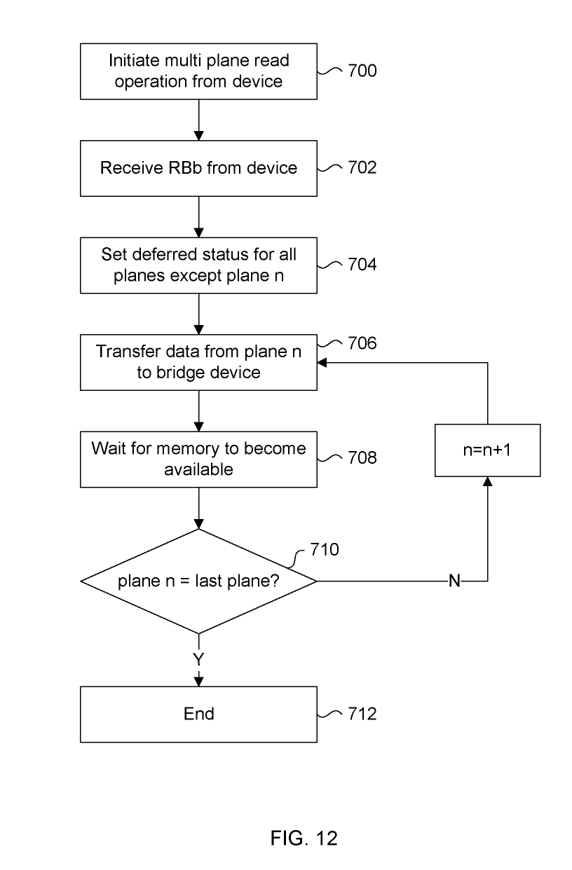

FIG. 12 is an example method embodiment for arbitrating data transfers from a multipage memory device to the data buffer having a storage capacity of a single page. The main difference between the present method of FIG. 12 and the method embodiment of FIG. 8 is that the single memory device only provides a single read/busy signal.

The method of FIG. 12 begins at step 700 where the bridge device initiates a multiplane read operation from a single device, by issuing the appropriate command to the memory device. At step 702, a memory device will drive its ready/busy signal RBb to a logic state indicating that its internal read operation for loading its multiple page buffers has been completed. The bridge device then sets all the planes to a deferred status at step 704, except for a first plane referred to in this example as plane n. It is noted that the bridge device is configured to prioritize the planes of the multiplane memory device in a predetermined order. At step 706, the page of data from the page buffer of plane n is transferred to the data buffer the bridge device. At step 708, the bridge device waits for the data buffer to become available, as it may be busy receiving data from plane n, or it may be busy outputting its contents to the memory controller. When the data buffer is available, a determination is made at step 710 to see if plane n was the last plane to read data from. In the present example iteration, there is at least one additional plane to read from, therefore the method returns to step 706 where the bridge device initiates transfer of data from the next predetermined plane n+1. The iteration of steps 706, 708 and 710 repeats until the page buffer data of the last plane of the multiplane memory device has been transferred to the data buffer of the bridge device. The multiplane arbitration method then ends at 712.

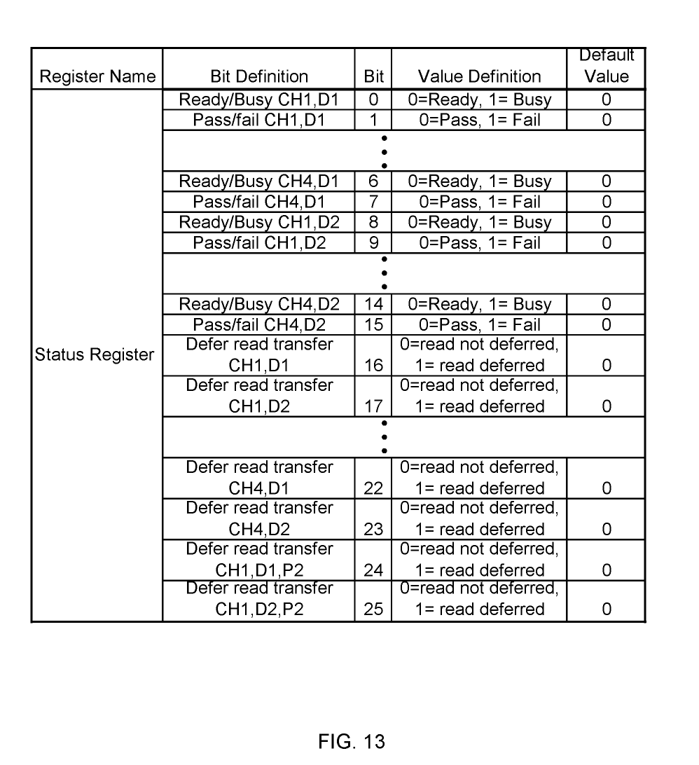

The previously described multiplane arbitration method embodiment uses status register bits for tracking the planes of the memory device which are placed in the deferred status. FIG. 13 shows an alternate status register definition table similar to the one shown in FIG. 9, but now includes bits 24 and 25. Bit 24 tracks the deferred status for plane 2 (P2) of device 1 (D1), connected to channel 1 (CH1). Bit 25 tracks the deferred status for plane 2 (P2) of device 2 (D2), connected to channel 1 (CH1). The present example presumes that each of the memory devices connected to channel 1 have two planes. Accordingly, a similar pair of status bits can be included for the other channels of the bridge device. Of course, additional status bits can be provided depending on the number of memory devices connected to each channel, and the number of planes within each of the memory devices.

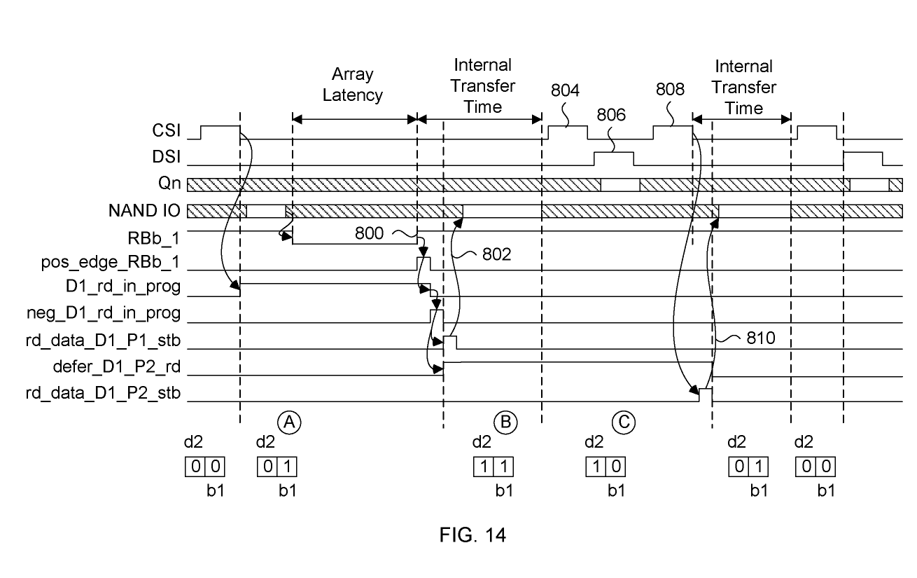

FIG. 14 is a sequence diagram illustrating an example two plane read operation from a single memory device connected to a channel of the bridge device. Many of the signal names appearing in FIG. 14 are the same as those shown and described for FIG. 10 with the exception of the bottom 3 signals which are used specifically for the presently described multiplane data transfer arbitration method. Signal rd_data_D1_P1_stb is a strobe signal which is generated in response to a pulse from signal neg_D1_rd_in_prog, and signals the bridge device to initiate a data transfer from the page buffer of plane 1 of the memory device to the data buffer of the bridge device. Signal defer_D1_P2_rd corresponds to the status bits for tracking the deferred state of plane 2 of memory device 1. Signal rd_data_D1_P2_stb functions in the same manner as rd_data_D1_P1_stb. The register bits shown along the bottom of FIG. 14 shows the logic states for the deferred status bit of plane 2 of memory device 1 (d2), and for the ‘Ready/Busy’ bit for memory device 1 (b1). Once again, it is noted that the time periods shown are not to scale.

The two-plane read operation is very similar to the memory device read operation except that, since there is only one memory device involved, there is no device-to-device contention for data buffer space. When the ready/busy signal RBb goes high, both pages of read data are available so the choice of which page buffer transferred to defer should be predetermined. In this example plane 2 is always deferred and it is hardwired into the logic. Alternatively it is possible to give priority to plane 2 or set the priority through a control register so that the priority can be changed dynamically. Other methods are also possible.

Referring to FIG. 14, after the bridge device receives the two-plane read command and passes it on to the target memory device, and sets signal D1_rd_in_prog to the logic level. Now memory device is considered to be in a busy state, and status bit b1 is set to a logical one as shown at ‘A’. Eventually, signal RBb_1 is driven high at 800 by the memory device, indicating that the internal read is finished and both pages are in their respective page buffers. The transition of signal RBb_1 to the high logic state triggers to events. First, strobe signal rd_data_D1_P1_stb is generated to initiate data transfer between the page buffer of plane 1 and the data buffer of the bridge device, as indicated at 802. Second, plane two of the memory device is set to the deferred status, as shown by signal defer_D1_P2_rd driven to the high logic state. As shown at ‘B’, deferred plane 2 status bit d2 is set to a logic 1. The memory controller reads out the contents of the data buffer at 804, which appears on the Qn output port in response to the DSI strobe signal occurring at 806. Once data buffer contents has been output from to the memory controller, the status of memory device 1 is released from its busy status, as shown at ‘C’ where bit is set to a logic 0. At 808, the memory controller re-issues the original two-plane read command which instructs the bridge device to transfer the second page of data to the bridge device data buffer. The bridge device responds by strobing rd_data_D1_P2_stb to initiate data transfer between the page buffer of plane 2 and the data buffer of the bridge device, as shown at 810. Furthermore, in response to the strobe signal, the status bit d2 is set to a logic 0 to remove the deferred status for plane 2. Then the controller reads that data out from the Qn output port, and the read operation is complete.

It should be noted that the two-plane read embodiment presented above can be combined with the two device read embodiment to yield a two-device-two-plane read. In such an embodiment, a first memory device to be ready reserves use of the data buffer of the bridge device for transferring data from its page buffers, while the remaining memory devices are held in a deferred a state.

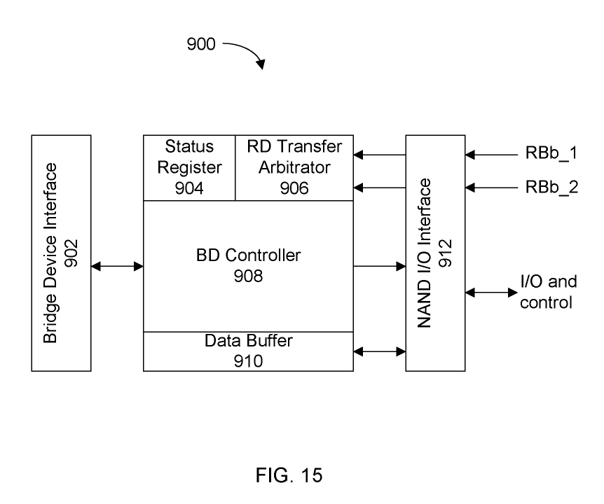

The previously described data transfer arbitration method embodiments of FIG. 7, FIG. 8 and FIG. 12 can be implemented as logic control circuitry within the bridge device. FIG. 15 is a simplified block diagram of the components for one channel of a bridge device, according to a present embodiment. The simplified bridge device 900 includes a bridge device interface 902, a status register 904, a read transfer arbitrator 906, a bridge device controller 908, a data buffer 910, and a memory I/O interface 912. The bridge device interface 902 receives global commands from the memory controller and provides them to the bridge device controller 908, which converts them into native commands compatible with the memory devices. The status register 904 can include the previously described status bits of FIG. 9 and FIG. 13 associated with this channel. The read transfer arbitrator 906 receives ready/busy signals provided from the memory devices connected to the channel, and in combination with the status register 904 and controller 908, controls which memory devices or planes should be placed into the deferred status. The present example assumes there are 2 memory devices connected to the channel.

The bridge device controller 908 converts the global commands received from the bridge device interface 902 into the native commands, and can provide output data including status register data to the memory controller via bridge device interface 902. The data buffer 910 is sized for storing one page of data received from a memory device, which corresponds in size to a page buffer of the memory device. Bridge device controller 908 controls data buffer 910 to receive data from the memory devices and to output its contents to the memory controller via bridge device interface 902. The bridge device controller is also responsible for updating the bits of status register 904. The I/O interface 912 provides the commands and control signals to the memory devices connected to the channel. In the present example, interface 912 is a NAND flash I/O interface for communicating with NAND flash memory devices. While FIG. 15 shows read transfer arbitrator 906 as being separate from bridge device controller 908, both circuits can be integrated with each other. As shown in the FIG. 15, the only memory device signals required by read transfer arbitrator 906 are the read/busy signals RBb_1 and RBb_2. These 2 signals are also used by the bridge device controller 908 to initiate generation of internal control signals, such as the ones shown in the previous sequence diagrams, and to update the bits of status register 904.

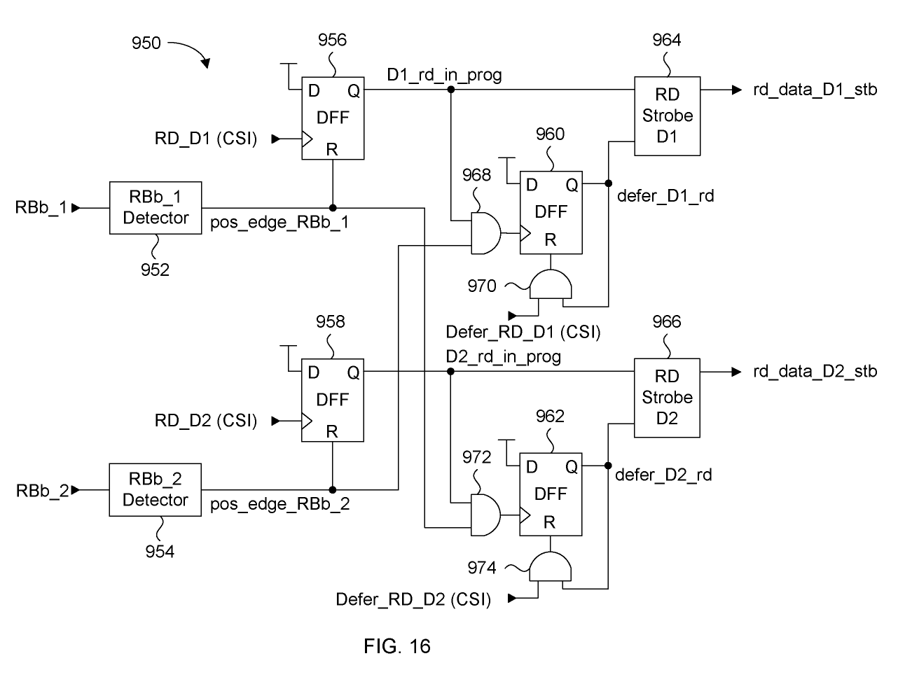

FIG. 16 is a circuit embodiment of a data transfer arbitrator circuit, according to a present embodiment. The arbitrator circuit 950 example circuit which can be used to generate some of the internal signals shown in the sequence diagram of FIG. 10. The circuit includes ready/busy signal detectors 952 and 954, read operation detectors 956 and 958, conflict detectors 960 and 962, read strobe generators 964 and 966, and AND logic gates 968, 970, 972 and 974. The circuit elements shown a FIG. 16 can be grouped as follows. Elements 952, 956, 960, 964, 968 and 970 form a first data transfer control circuit for memory device D1. Elements 954, 958, 962, 966, 972 and 974 form a second data transfer control circuit for memory device D2. Generally, each data transfer control circuits operates to generate a read data strobe signal that triggers the bridge device controller 908 to initiate data transfer between the respective memory device and the data buffer of the bridge device. However, the first and the second data transfer control circuits are interconnected such that one data transfer control circuit can inhibit the other from generating its read data strobe signal.

Following is a brief discussion of the circuit of FIG. 16, with reference to the elements of the 1st data transfer control circuit. It is noted that the signal names appearing in FIG. 16 are the same as those used in FIG. 10. Starting with read operation detector 956, implemented as a D type flip-flop, a read operation signal RD_D1 (CSI) is detected to drive D1_rd_in_prog to a logic 1. Ready/busy signal detector 952 is configured to detect a rising edge of RBb_1, and pulses pos_edge_RBb_1 when this event occurs. This pulse will reset flip-flop 956 to drive D1_rd_in_prog to a logic 0. Read strobe generator 964 will generate the rd_data_D1_stb, provided signal defer_D1_rd is at the inactive logic 0 state. The rd_data_D1_stb signal can be used by BD controller 908 of FIG. 15 to issue a data transfer command to the corresponding memory device. Flip-flop 960 will drive defer_D1_rd to the active logic 1 state only when pos_edge_RBb_2 and D1_rd_in_prog are at logic 1 states, via AND logic gate 968. Therefore, if RBb_2 was detected before RBb_1, then defer_D1_rd is driven to logic 1 and the generation of strobe signal rd_data_D1_stb is inhibited. In the event that defer_D1_rd is at logic 1, then a subsequent read operation signal by Defer_RD_D1 (CSI) will reset flip-flop 960 via AND logic gate 970 to drive defer_D1_rd to a logic 0 which allows read strobe generators 964 to generate its strobe signal.

The second data transfer control circuit has an identical configuration to that of the first data transfer control circuit, except that AND logic gate 972 receives pos_edge_RBb_1 and AND logic gate 974 receives Defer_RD_D2 (CSI). Therefore, the second data transfer control circuit can be inhibited from generating its strobe signal rd_data_D2_stb if a rising edge of RBb_1 is detected first. The read strobe generator 964 can include any logic which detects the falling edge of D1_rd_in_prog and generates a rd_data_D1_stb logic 1 pulse in response thereto while defer_D1_rd is at a logic 0 state, but is inhibited from doing so when defer_D1_rd is at a logic 1 state. Furthermore, the read strobe generator 964 logic should also generate a rd_data_D1_stb logic 1 pulse in response to a falling transition of defer_D1_rd. The read strobe generator 966 can include the same logic circuitry. The rd_data_D2_stb signal can be used by BD controller 908 of FIG. 15 to issue a data transfer command to the corresponding memory device.

The system and device in accordance with the techniques described herein are applicable to a memory system having a plurality of devices connected in series. The devices are, for example, memory devices, such as dynamic random access memories (DRAMs), static random access memories (SRAMs), flash memories, DiNOR Flash EEPROM memories, Serial Flash EEPROM memories, Ferro RAM memories, Magneto RAM memories, Phase Change RAM memories, and any other suitable type of memory.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention.

It will be understood that when an element is herein referred to as being “connected” or “coupled” to another element, it can be directly connected or coupled to the other element or intervening elements may be present. In contrast, when an element is herein referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Figures in this application are not necessarily to scale. For example, in FIG. 5 the relative sizes of the bridge device 302 and discrete memory devices 304 are not to scale, and a fabricated bridge device is orders of magnitude smaller in area than the discrete memory devices 304.

Certain adaptations and modifications of the described embodiments can be made. Therefore, the above-discussed embodiments are considered to be illustrative and not restrictive.

What is claimed is:

1. A method for controlling data transfer from two page buffer sources to a data buffer, comprising:
initiating read operations in the two page buffer sources;
automatically transferring data from a first page buffer source of the two page buffer sources that completes a read operation, to the data buffer;
inhibiting transfer of data from a second page buffer source of the two page buffer sources when the second page buffer source completes a read operation and the data buffer is busy;
waiting for the data buffer to become available; and,
transferring data from the second page buffer source when the data buffer is available.

2. The method of claim 1, wherein each of the two page buffer sources and the data buffer are sized to store one page of data.

3. The method of claim 1, wherein the first page buffer source is a first memory device and the second page buffer source is a second memory device.

4. The method of claim 1, wherein the first page buffer source is a first page buffer of a memory device and the second page buffer source is a second page buffer of the memory device.

5. The method of claim 1, wherein automatically transferring data includes receiving a ready signal from the first page buffer source.

6. The method of claim 5, wherein automatically transferring data further includes issuing a data transfer command to the first page buffer source after the read signal is received from the first page buffer source.

7. The method of claim 1, wherein inhibiting transfer of data includes setting a deferred status of the second page buffer source if the read operation for the second page buffer source is in progress.

8. The method of claim 7, wherein setting a deferred status includes setting a deferred status register corresponding to the second page buffer source to a deferred state.

9. The method of claim 8, wherein transferring data includes setting the deferred status register to a non-deferred state.

10. The method of claim 2, wherein inhibiting transfer of data includes receiving a ready signal from the second page buffer source.

11. The method of claim 9, further including inhibiting issuance of a data transfer command to the second page buffer source after the read signal from the second page buffer source is received and the second page buffer source is set to the deferred status.

12. The method of claim 1, wherein waiting includes outputting the data of the first page buffer source stored in the data buffer.

13. The method of claim 11, wherein transferring data includes issuing a data transfer command to the second page buffer source after the data buffer has finished outputting the data of the first page buffer source.

14. The method of claim 1, wherein inhibiting transfer of data includes setting a deferred status for the second page buffer source when the ready signal is received.

15. The method of claim 14, wherein setting a deferred status includes setting a deferred status register corresponding to the second page buffer source to a deferred state.

16. A method for reading data from a bridge device having two page buffer sources connected to a channel of the bridge device, comprising:
issuing page read commands for reading data from the two page buffer sources to the bridge device;
determining a first page buffer source of the two page buffer sources is in a ready state and is in a non-deferred state for indicating that data of the first page buffer source is stored in a data buffer of the bridge device;
burst reading data from the data buffer of the bridge device;
re-issuing a page read command to a second page buffer source of the two page buffer sources if the second page buffer source is in a ready state and is in a deferred state for transferring data of the second page buffer source to the data buffer of the bridge device; and,
burst reading data from the data buffer of the bridge device.

17. The method of claim 16, wherein issuing page read commands includes issuing a first page read command to the first page buffer source, followed by issuing a second page read command to the second page buffer source after a predetermined latency period.

18. The method of claim 17, wherein the first page buffer source reads a page of data from a memory array and transfers the page of data to the data buffer of the bridge device in response to the first page read command.

19. The method of claim 18, wherein the bridge device sets a deferred status for the second page buffer source when the transfer of the page of data to the data buffer is initiated.

20. The method of claim 16, wherein determining includes reading status registers of the bridge device indicating the ready state and the non-deferred state corresponding to each of the first page buffer source and the second page buffer source.

21. The method of claim 16, wherein re-issuing includes reading the status registers of the bridge device to determine if the second page buffer source is in the ready state and in the deferred state.

22. The method of claim 21, wherein the second page buffer source reads a page of data from a memory array and transfers the page of data to the data buffer of the bridge device in response to the page read command.

23. The method of claim 22, wherein the status registers of the bridge device are read to determine if the second page buffer source is in a ready state for indicating that data of the second page buffer source is stored in a data buffer of the bridge device.

24. A bridge device for receiving read data from a first page buffer source and a second page buffer source, comprising:
a data buffer having a predetermined size for receiving first read data from the first page buffer source and the second read data from the second page buffer source, the first read data and the second read data being the predetermined size;
an arbitrator circuit for generating a first read transfer signal in response to detecting a first page buffer source being ready to provide the first read data, and for inhibiting generation of a second read transfer signal when the second page buffer source becomes ready to provide the second read data at least when the first page buffer is ready to provide the first read data;
a controller for issuing a data transfer command to the first page buffer source in response to the first read transfer signal for transferring the first read data from the first page buffer source to the data buffer from the first page buffer source to the data buffer.

25. The bridge device of claim 24, wherein the first page buffer source is a first memory device and the second page buffer source is a second memory device.

26. The bridge device of claim 25, wherein the arbitrator circuit receives a first ready/busy signal transition from the first memory device indicating that the first memory device you is ready to provide the first read data, and receives a second ready/busy signal transition from the second page buffer source after the first ready/busy signal transition.

27. The bridge device of claim 24, wherein the first page buffer is a first plane of a memory device and the second page buffer source is a second plane of the memory device.

28. The bridge device of claim 27, wherein the arbitrator circuit receives a ready/busy signal transition from the memory device indicating that the first plane and the second plane are ready to provide the first read data and the second read data.
